(19) United States
(12) Patent Application Publication
(10) Pub. No.: US 2020/0156537 A1
(43) Pub. Date: May 21, 2020

(54) VOICE ACTIVATED VEHICLE ALARM

(71) Applicant: GM GLOBAL TECHNOLOGY OPERATIONS LLC, Detroit, MI (US)

(72) Inventors: Richard L. Elswick, Warren, MI (US); Aditya S. Kamini, Bloomfield Hills, MI (US)

(21) Appl. No.: 16/196,648

(22) Filed: Nov. 20, 2018

(51) Int. Cl. B60Q 5/00; G10L 15/22; B60Q 1/00

(52) U.S. Cl. CPC B60Q 5/005; G10L 15/22; B60Q 2900/30; G10L 2015/223; B60Q 1/00

(57) ABSTRACT

One general aspect includes a method for remotely activating a vehicle alarm via a voice command, the method including: receiving, via a processor, a voice command to activate a home emergency sequence from a system user; based on the voice command, via the processor, determining if one or more vehicles are located in proximity to a residence of the system user; and when the one or more vehicles are located in proximity to the residence, via the processor, transmitting a vehicle alarm notification to the one or more vehicles, where the vehicle alarm notification is configured to activate a horn system and a light system of the one or more vehicles in an ordered sequence.

Burglary can be a serious issue, especially if the home owner victim is inside of their home when the home invasion is occurring. Home owners are often left to hide somewhere in their home without any way of getting help. What's worse, when the home owner attempts to yell for help or otherwise get the attention of any would-be rescuers, they greatly risk revealing their hiding location and further place themselves in danger. It is therefore desirable to provide a system and method that will allow a home owner to generate an emergency alert during a home invasion situation which can get the attention of nearby neighbors and pedestrians or any other would-be rescuers. Additionally, it is desirable for this emergency alert to be generated by a vehicle located right outside of the burglarized home, to prevent disclosure of the home owner's hiding spot during this unwelcome event. Moreover, other desirable features and characteristics of the present invention will become apparent from the subsequent detailed description of the invention and the appended claims, taken in conjunction with the accompanying drawings and this background of the invention.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for remotely activating a vehicle alarm via a voice command, the method including: receiving, via a processor, a voice command to activate a home emergency sequence from a system user; based on the voice command, via the processor, determining if one or more vehicles are located in proximity to a residence of the system user; and when the one or more vehicles are located in proximity to the residence, via the processor, transmitting a vehicle alarm notification to the one or more vehicles, where the vehicle alarm notification is configured to activate a horn system and a light system of the one or more vehicles in an ordered sequence. Other embodiments of this aspect include corresponding computer systems, apparatus, and computer programs recorded on one or more computer storage devices, each configured to perform the actions of the methods.

Implementations may include one or more of the following features. The method further including: receiving, via the processor, an indication that the horn and light systems of the one or more vehicles have been activated; and in response to receiving the indication, via the processor, transmitting a first audible notification to the user, where the first audible notification is configured to notify the user that the horn and light systems of the one or more vehicles have been activated. The method further including: where the first audible notification is further configured to inquire whether the user wishes to inform an emergency services provider; and when the user wishes to inform the emergency services provider, via the processor, transmitting an emergency services notification to the emergency services provider, where the emergency services notification is configured to inform the emergency services provider that an emergency event may be occurring at the residence of the user. The method further including, when the one or more vehicles are located beyond the proximity of the residence, via the processor, transmitting a second audible notification to the user, where the second audible notification is configured to notify the user that the one or more vehicles are beyond the proximity of the residence. The method further including: receiving, via the processor, vehicle location data from the one or more vehicles; and where the determination of whether the one or more vehicles are located in proximity to the residence of the system user is based on the vehicle location data. The method further including: receiving, via the processor, a virtual map from a remote entity; establishing, via the processor, the residence of the system user within the virtual map; and where the determination of whether the one or more vehicles are located in proximity to the residence of the system user is based on the residence of the system user within the virtual map. The method further including: receiving, via the processor, a virtual map from a remote entity; establishing, via the processor, the residence of the system user within the virtual map; receiving, via the processor, vehicle location data from the one or more vehicles; establishing, via the processor, a virtual geographic boundary around the residence of the system user within the virtual map; and where a vehicle of the one or more vehicles is considered to be located in proximity to the residence of the system user when the vehicle location data shows the vehicle is within the established virtual geographic boundary. Implementations of the described techniques may include hardware, a method or process, or computer software on a computer-accessible medium.

One general aspect includes a system for remotely activating a vehicle alarm via a voice command, the system including: a memory configured to include one or more executable instructions and a processor configured to execute the executable instructions, where the executable instructions enable the processor to: receive a voice command to activate a home emergency sequence from a system user; based on the voice command, determine if one or more vehicles are located in proximity to a residence of the system user; and when the one or more vehicles are located in proximity to the residence, transmit a vehicle alarm notification to the one or more vehicles, where the vehicle alarm notification is configured to activate a horn system and a light system of the one or more vehicles in an ordered sequence. Other embodiments of this aspect include corresponding computer systems, apparatus, and computer programs recorded on one or more computer storage devices, each configured to perform the actions of the methods.

Implementations may include one or more of the following features. The system where the executable instructions further enable the processor to: receive an indication that the horn and light systems of the one or more vehicles have been activated; and in response to receiving the indication, transmit a first audible notification to the user, where the first audible notification is configured to notify the user that the horn and light systems of the one or more vehicles have been activated. The system where the executable instructions further enable the processor to: where the first audible notification is further configured to inquire whether the user wishes to inform an emergency services provider; and when the user wishes to inform the emergency services provider, transmit an emergency services notification to the emergency services provider, where the emergency services notification is configured to inform the emergency services provider that an emergency event may be occurring at the residence of the user. The system where the executable instructions further enable the processor to, when the one or more vehicles are located beyond the proximity of the residence, transmit a second audible notification to the user, where the second audible notification is configured to notify the user that the one or more vehicles are beyond the proximity of the residence. The system where the executable instructions further enable the processor to: receive vehicle location data from the one or more vehicles; and where the determination of whether the one or more vehicles are located in proximity to the residence of the system user is based on the vehicle location data. The system where the executable instructions further enable the processor to: receive a virtual map from a remote entity; establish the residence of the system user within the virtual map; and where the determination of whether the one or more vehicles are located in proximity to the residence of the system user is based on the residence of the system user within the virtual map. The system where the executable instructions further enable the processor to: receive a virtual map from a remote entity; establish the residence of the system user within the virtual map; receive vehicle location data from the one or more vehicles; establish a virtual geographic boundary around the residence of the system user within the virtual map; and where a vehicle of the one or more vehicles is considered to be located in proximity to the residence of the system user when the vehicle location data shows the vehicle is within the established virtual geographic boundary. Implementations of the described techniques may include hardware, a method or process, or computer software on a computer-accessible medium.

One general aspect includes a non-transitory and machine-readable medium having stored thereon executable instructions adapted to remotely activate a vehicle alarm via a voice command, which when provided to a processor and executed thereby, causes the processor to: receive a voice command to activate a home emergency sequence from a system user; based on the voice command, determine if one or more vehicles are located in proximity to a residence of the system user; and when the one or more vehicles are located in proximity to the residence, transmit a vehicle alarm notification to the one or more vehicles, where the vehicle alarm notification is configured to activate a horn system and a light system of the one or more vehicles in an ordered sequence. Other embodiments of this aspect include corresponding computer systems, apparatus, and computer programs recorded on one or more computer storage devices, each configured to perform the actions of the methods.

Implementations may include one or more of the following features. The non-transitory and machine-readable memory which further causes the processor to: receive an indication that the horn and light systems of the one or more vehicles have been activated; and in response to receiving the indication, transmit a first audible notification to the user, where the first audible notification is configured to notify the user that the horn and light systems of the one or more vehicles have been activated. The non-transitory and machine-readable memory which further causes the processor to: where the first audible notification is further configured to inquire whether the user wishes to inform an emergency services provider; and when the user wishes to inform the emergency services provider, transmit an emergency services notification to the emergency services provider, where the emergency services notification is configured to inform the emergency services provider that an emergency event may be occurring at the residence of the user. The non-transitory and machine-readable memory which further causes the processor to, when the one or more vehicles are located beyond the proximity of the residence, transmit a second audible notification to the user, where the second audible notification is configured to notify the user that the one or more vehicles are beyond the proximity of the residence. The non-transitory and machine-readable memory which further causes the processor to: receive vehicle location data from the one or more vehicles; and where the determination of whether the one or more vehicles are located in proximity to the residence of the system user is based on the vehicle location data. The non-transitory and machine-readable memory which further causes the processor to: receive a virtual map from a remote entity; establish the residence of the system user within the virtual map; receive vehicle location data from the one or more vehicles; establish a virtual geographic boundary around the residence of the system user within the virtual map; and where a vehicle of the one or more vehicles is considered to be located in proximity to the residence of the system user when the vehicle location data shows the vehicle is within the established virtual geographic boundary. Implementations of the described techniques may include hardware, a method or process, or computer software on a computer-accessible medium.

The above features and advantages and other features and advantages of the present teachings are readily apparent from the following detailed description for carrying out the teachings when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of a communications system that is capable of utilizing the system and method disclosed herein;

FIG. 2 is a block diagram depicting an embodiment of an automatic speech recognition (ASR) system capable of utilizing the system and method disclosed herein;

FIG. 3 is a flowchart of an exemplary process for remotely activating a vehicle alarm via a voice command;

FIG. 4 depicts an application of an exemplary aspect of the process of FIG. 3 in accordance with one or more exemplary embodiments; and

FIG. 5 depicts an application of an exemplary aspect of the process of FIG. 3 in accordance with one or more exemplary embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present system and/or method. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

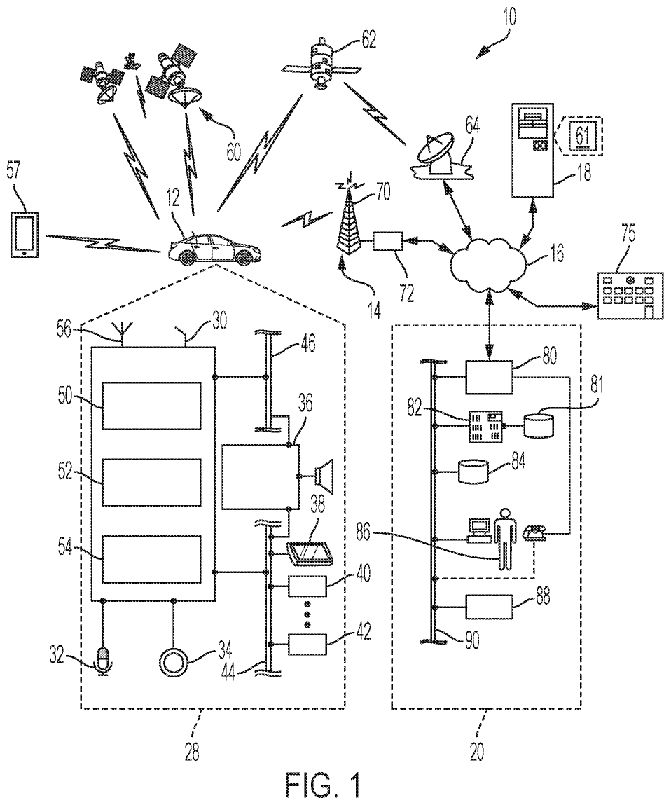

With reference to FIG. 1, there is shown an operating environment that includes, among other features, a mobile vehicle communications system 10 and that can be used to implement the method disclosed herein. Communications system 10 generally includes a vehicle 12, one or more wireless carrier systems 14, a land communications network 16, a computer 18, and a data center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including, but not limited to, motorcycles, trucks, busses, sports utility vehicles (SUVs), recreational vehicles (RVs), construction vehicles (e.g., bulldozers), trains, trolleys, marine vessels (e.g., boats), aircraft, helicopters, amusement park vehicles, farm equipment, golf carts, trams, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit 30 such as, for example, the microphone 32 and pushbutton(s) 34, whereas others are indirectly connected using one or more network connections, such as a communications bus 44 or an entertainment bus 46. Examples of suitable network connections include a controller area network (CAN), WIFI, Bluetooth and Bluetooth Low Energy, a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket transceiver device that is installed in the vehicle and that enables wireless voice and/or data communication over wireless carrier system 14 and via wireless networking. This enables the vehicle to communicate with data center 20, other telematics-enabled vehicles, or some other entity or device. The telematics unit 30 preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor 86 or voice response unit at the data center 20) and data communication (e.g., to provide GPS location data or vehicle diagnostic data to the data center 20), the system can utilize a single call over a voice channel and switch as needed between voice and data transmission over the voice channel, and this can be done using techniques known to those skilled in the art.

According to one embodiment, telematics unit 30 utilizes cellular communication according to standards such as LTE or 5G and thus includes a standard cellular chipset 50 for voice communications like hands-free calling, a wireless modem for data transmission (i.e., transceiver), an electronic processing device 52, at least one digital memory device 54, and an antenna system 56. It should be appreciated that the modem can either be implemented through software that is stored in the telematics unit and is executed by processor 52, or it can be a separate hardware component located internal or external to telematics unit 30. The modem can operate using any number of different standards or protocols such as, but not limited to, WCDMA, LTE, and 5G. Wireless networking between vehicle 12 and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

One of the networked devices that can communicate with the telematics unit 30 is a mobile computing device 57, such as a smart phone, personal laptop computer, smart wearable device, or tablet computer having two-way communication capabilities, a netbook computer, or any suitable combinations thereof. The mobile computing device 57 can include computer processing capability, a transceiver capable of communicating with wireless carrier system 14, and/or a GPS module capable of receiving GPS satellite signals and generating GPS coordinates based on those signals. Examples of the mobile computing device 57 include the iPhone™ manufactured by Apple, Inc. and the Pixel™ manufactured by HTC, Inc. as well as others. While the mobile computing device 57 may include the ability to communicate via cellular communications using the wireless carrier system 14, this is not always the case. For instance, Apple manufactures devices such as the various models of the iPad™ and iPod Touch™ that include the processing capability, and the ability to communicate over a short-range wireless communication link such as, but not limited to, WIFI and Bluetooth. However, the iPod Touch™ and some iPads™ do not have cellular communication capabilities. Even so, these and other similar devices may be used or considered a type of wireless device, such as the mobile computing device 57, for the purposes of the method described herein.

Mobile device 57 may be used inside or outside of vehicle 12, and may be coupled to the vehicle by wire or wirelessly. The mobile device also may be configured to provide services according to a subscription agreement with a third-party facility or wireless/telephone service provider. It should be appreciated that various service providers may utilize the wireless carrier system 14 and that the service provider of the telematics unit 30 may not necessarily be the same as the service provider of the mobile devices 57.

When using a short-range wireless connection (SRWC) protocol (e.g., Bluetooth/Bluetooth Low Energy or Wi-Fi), mobile computing device 57 and telematics unit 30 may pair/link one with another when within a wireless range (e.g., prior to experiencing a disconnection from the wireless network). In order to pair, mobile computing device 57 and telematics unit 30 may act in a BEACON or DISCOVERABLE MODE having a general identification (ID); SRWC pairing is known to skilled artisans. The general identifier (ID) may include, e.g., the device's name, unique identifier (e.g., serial number), class, available services, and other suitable technical information. Mobile computing device 57 and telematics unit 30 may also pair via a non-beacon mode. In these instances, the call center 20 may participate in pairing mobile computing device 57 and telematics unit 30. For example, the call center 20 may initiate the inquiry procedure between the telematics unit 30 and mobile computing device 57. And call center 20 may identify mobile computing device 57 as belonging to the user of vehicle 12 and then receive from the mobile computing device 57 it's unique mobile device identifier and authorize the telematics unit 30 via the wireless communication system 14 to pair with this particular ID.

Once SRWC is established, the devices may be considered bonded as will be appreciated by skilled artisans (i.e., they may recognize one another and/or connect automatically when they are in a predetermined proximity or range of one other. In other words—they may become, at least temporarily, network participants). Call center 20 may also authorize SRWC on an individual basis before completion.

Telematics Controller 52 (processor) can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Telematics Controller 52 executes various types of digitally-stored instructions, such as software or firmware programs stored in memory 54, which enable the telematics unit to provide a wide variety of services. For instance, controller 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services provided in connection with one or more vehicle system modules 42 (VSM); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit 30 is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to data center 20 or other remote computer system, such as computer 18, for other purposes, such as fleet management. Also, new or updated map data can be downloaded to the GPS module 40 from the data center 20 via the telematics unit 30.

Apart from the audio system 36 and GPS module 40, the vehicle 12 can include other VSMs 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests.

As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art.

The pushbutton(s) 34 allow manual user input into the telematics unit 30 to initiate wireless telephone calls and provide other data, response, or control input. Separate pushbuttons can be used for initiating emergency calls versus regular service assistance calls to the data center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM, media streaming services (e.g., PANDORA RADIO™, SPOTIFY™, etc.), satellite radio, CD, DVD, and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions (i.e., capable of GUI implementation). Audio system 36 may also generate at least one audio notification to announce such third-party contact information is being exhibited on display 38 and/or may generate an audio notification which independently announces the third-party contact information. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more cellular network infrastructures (CNI) 72, as well as any other networking components required to connect wireless carrier system 14 with land network 16. Each cell tower 70 includes sending and receiving antennas and a base station, with the base stations from different cell towers being connected to the CNI 72 either directly or via intermediary equipment such as a base station controller. Cellular system 14 can implement any suitable communications technology, including for example, analog technologies such as AMPS, or the newer digital technologies such as, but not limited to, 4G LTE and 5G. As will be appreciated by skilled artisans, various cell tower/base station/CNI arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to data center 20 as well as emergency services provider 75 (i.e., a fire department, hospital or police station having uniformed or otherwise identified employees or contractors). For example, land network 16 may include a public switched telephone network (PSTN) such as that used to provide hardwired telephony, packet-switched data communications, and the Internet infrastructure (i.e., a network of interconnected computing device nodes). One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, data center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer (e.g., a SIP Presence server) where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other services information is provided, whether by communicating with the vehicle 12 or data center 20, a third-party services provider, or some combination thereof. Computer 18 can, for example, store a web mapping service application 61 (e.g., GOOGLE MAPS™, APPLE MAPS™, etc.) that offers satellite imagery, street maps, 360° panoramic views of streets (Street View), real-time traffic conditions (e.g., GOOGLE TRAFFIC™), and route planning for traveling by foot, vehicle, bicycle, or public transportation. For example, mapping application 61 may provide interactive virtual map data to telematics unit 30 to be exhibited on display 38. The interactive map data may moreover provide support for proximity information and the establishing of a geofence for a given location (e.g., the user's residence). As skilled artists will understand, the geofence can use GPS or RFID technology to create a virtual geographic boundary (i.e., a virtual perimeter for a real-world geographic area, for example, a radius around a residence or a predefined set of boundaries around the residence), which enables a response when a device or object (e.g., vehicle 12) is determined to be within that virtual geographic boundary. A computer 18 can also be used for providing Internet connectivity such as DNS services or as a network address server that uses DHCP or other suitable protocol to assign an IP address to the vehicle 12.

Data center 20 is designed to provide the vehicle electronics 28 with a number of different system backend functions and, according to the exemplary embodiment shown here, generally includes one or more switches 80, servers 82, databases 84, live advisors 86, as well as an automated voice response system (VRS) 88, all of which are known in the art. These various data center components are preferably coupled to one another via a wired or wireless local area network 90. Switch 80, which can be a private branch exchange (PBX) switch, routes incoming signals so that voice transmissions are usually sent to either the live advisor 86 by regular phone, backend computer, or to the automated voice response system 88 using VoIP. Server 82 can incorporate a data controller 81 which essentially controls the operations of server 82. Server 82 may control data information as well as act as a transceiver to send and/or receive the data information (i.e., data transmissions) from one or more of the data bases 84, telematics unit 30, and mobile computing device 57.

Controller 81 is capable of reading executable instructions stored in a non-transitory machine readable medium and may include one or more from among a processor, a microprocessor, a central processing unit (CPU), a graphics processor, Application Specific Integrated Circuits (ASICs), Field-Programmable Gate Arrays (FPGAs), state machines, and a combination of hardware, software and firmware components. The live advisor phone can also use VoIP as indicated by the broken line in FIG. 1. VoIP and other data communication through the switch 80 is implemented via a modem (i.e., a transceiver), connected between the land communications network 16 and local area network 90.

Data transmissions are passed via the modem to server 82 and/or database 84. Database 84 can store account information such as vehicle dynamics information and other pertinent subscriber information. Data transmissions may also be conducted by wireless systems, such as 802.11x, GPRS, and the like. Although the illustrated embodiment has been described as it would be used in conjunction with a manned data center 20 using live advisor 86, it will be appreciated that the data center can instead utilize VRS 88 as an automated advisor or, a combination of VRS 88 and the live advisor 86 can be used.

As mentioned above, emergency services provider 75 can be an emergency services dispatch for a hospital, police station, fire department, or some other type of emergency medical technician group. As follows, the emergency services provider 75 has uniformed or otherwise identified employees or contractors that are specifically trained to rescue helpless victims from unfortunate situations. Emergency service provider 75 may, for example, be contacted via a common emergency phone number known to the general public (e.g., 9-1-1 in the United States).

### Automatic Speech Recognition System

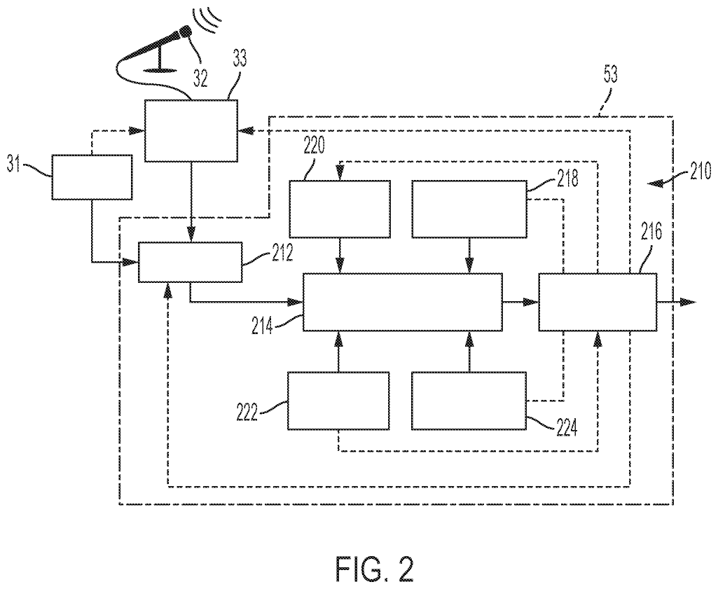

Turning now to FIG. 2, there is shown an illustrative architecture for an ASR system 210 that can be used to enable the presently disclosed method. In general, a vehicle occupant vocally interacts with an automatic speech recognition system (ASR) for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, vehicle device or device function control, or the like. Generally, ASR extracts acoustic data from human speech, compares and contrasts the acoustic data to stored subword data, selects an appropriate subword which can be concatenated with other selected subwords, and outputs the concatenated subwords or words for post-processing such as dictation or transcription, address book dialing, storing to memory, training ASR models or adaptation parameters, or the like.

ASR systems and devices are generally known to those skilled in the art and FIG. 2 illustrates just one specific illustrative ASR system 210. The system 210 includes a device to receive speech such as a microphone 32, and an acoustic interface 33 such as a sound card having an analog to digital converter to digitize the speech into acoustic data. The system 210 also includes a memory such as or similar to telematics memory 54, mobile device memory 57, memory 84, and the memory of computer 18 for storing the acoustic data and storing speech recognition software and databases, and a processor such as or similar to the telematics processor 52, mobile device processor 57, data controller 81, and computer 18 to process the acoustic data. The processor functions with the memory and in conjunction with the following modules: one or more front-end processors or pre-processor software modules 212 for parsing streams of the acoustic data of the speech into parametric representations such as acoustic features; one or more decoder software modules 214 for decoding the acoustic features to yield digital subword or word output data corresponding to the input speech utterances: and one or more post-processor software modules 216 for using the output data from the decoder module(s) 214 for any suitable purpose.

The system 210 can also receive speech from any other suitable audio source(s) 31, which can be directly communicated with the pre-processor software module(s) 212 as shown in solid line or indirectly communicated therewith via the acoustic interface 33. The audio source(s) 31 can include, for example, a telephonic source of audio such as a voice mail system, or other telephonic services of any kind.

One or more modules or models can be used as input to the decoder module(s) 214. First, grammar and/or lexicon model(s) 218 can provide rules governing which words can logically follow other words to form valid sentences. In a broad sense, a grammar can define a universe of vocabulary the system 210 expects at any given time in any given ASR mode. For example, if the system 210 is in a training mode for training commands, then the grammar model(s) 218 can include all commands known to and used by the system 210. In another example, if the system 210 is in a main menu mode, then the active grammar model(s) 218 can include all main menu commands expected by the system 210 such as call, dial, exit, delete, directory, or the like. Second, acoustic model(s) 220 assist with selection of most likely subwords or words corresponding to input from the pre-processor module(s) 212. Third, word model(s) 222 and sentence/language model(s) 224 provide rules, syntax, and/or semantics in placing the selected subwords or words into word or sentence context. Also, the sentence/language model(s) 224 can define a universe of sentences the system 210 expects at any given time in any given ASR mode, and/or can provide rules, etc., governing which sentences can logically follow other sentences to form valid extended speech.

According to an alternative illustrative embodiment, some or all of the ASR system 210 can be resident on, and processed using, computing equipment conveniently packaged in a casing module to create a virtual assistant device 53 (e.g., AMAZON ECHO™, GOOGLE HOME™, APPLE HOMEPOD™, etc.), embedded into mobile computing device 57, or at a remote location from the microphone 32 such as, but not limited to, the call center 20. For example, speech recognition software can be processed using processors of one of the servers 82 in the call center 20. In other words, the ASR system 210 can be resident in the casing module, mobile computing device 57, and/or resident at the call center 20 in any desirable manner.

First, acoustic data is extracted from human speech wherein a ASR system user speaks into the microphone 32, which converts the utterances into electrical signals and communicates such signals to the acoustic interface 33. A sound-responsive element in the microphone 32 captures the user's speech utterances as variations in air pressure and converts the utterances into corresponding variations of analog electrical signals such as direct current or voltage. The acoustic interface 33 receives the analog electrical signals, which are first sampled such that values of the analog signal are captured at discrete instants of time, and are then quantized such that the amplitudes of the analog signals are converted at each sampling instant into a continuous stream of digital speech data. In other words, the acoustic interface 33 converts the analog electrical signals into digital electronic signals. The digital data are binary bits which are buffered in the telematics memory 54 and then processed by the telematics processor 52 or can be processed as they are initially received by the processor 52 in real-time.

Second, the pre-processor module(s) 212 transforms the continuous stream of digital speech data into discrete sequences of acoustic parameters. More specifically, the processor 52 executes the pre-processor module(s) 212 to segment the digital speech data into overlapping phonetic or acoustic frames of, for example, 10-30 in duration. The frames correspond to acoustic subwords such as syllables, demi-syllables, phones, diphones, phonemes, or the like. The pre-processor module(s) 212 also performs phonetic analysis to extract acoustic parameters from the occupant's speech such as time-varying feature vectors, from within each frame. Utterances within the user's speech can be represented as sequences of these feature vectors. For example, and as known to those skilled in the art, feature vectors can be extracted and can include, for example, vocal pitch, energy profiles, spectral attributes, and/or cepstral coefficients that can be obtained by performing Fourier transforms of the frames and decorrelating acoustic spectra using cosine transforms. Acoustic frames and corresponding parameters covering a particular duration of speech are concatenated into unknown test pattern of speech to be decoded.

Third, the processor executes the decoder module(s) 214 to process the incoming feature vectors of each test pattern. The decoder module(s) 214 is also known as a recognition engine or classifier, and uses stored known reference patterns of speech. Like the test patterns, the reference patterns are defined as a concatenation of related acoustic frames and corresponding parameters. The decoder module(s) 214 compares and contrasts the acoustic feature vectors of a subword test pattern to be recognized with stored subword reference patterns, assesses the magnitude of the differences or similarities therebetween, and ultimately uses decision logic to choose a best matching subword as the recognized subword. In general, the best matching subword is that which corresponds to the stored known reference pattern that has a minimum dissimilarity to, or highest probability of being, the test pattern as determined by any of various techniques known to those skilled in the art to analyze and recognize subwords. Such techniques can include dynamic time-warping classifiers, artificial intelligence techniques, neural networks, free phoneme recognizers, and/or probabilistic pattern matchers such as Hidden Markov Model (HMM) engines.

HMM engines are known to those skilled in the art for producing multiple speech recognition model hypotheses of acoustic input. The hypotheses are considered in ultimately identifying and selecting that recognition output which represents the most probable correct decoding of the acoustic input via feature analysis of the speech. More specifically, an HMM engine generates statistical models in the form of an “N-best” list of subword model hypotheses ranked according to HMM-calculated confidence values or probabilities of an observed sequence of acoustic data given one or another subword such as by the application of Bayes' Theorem.

A Bayesian HMM process identifies a best hypothesis corresponding to the most probable utterance or subword sequence for a given observation sequence of acoustic feature vectors, and its confidence values can depend on a variety of factors including acoustic signal-to-noise ratios associated with incoming acoustic data. The HMM can also include a statistical distribution called a mixture of diagonal Gaussians, which yields a likelihood score for each observed feature vector of each subword, which scores can be used to reorder the N-best list of hypotheses. The HMM engine can also identify and select a subword whose model likelihood score is highest.

In a similar manner, individual HMMs for a sequence of subwords can be concatenated to establish single or multiple word HMM. Thereafter, an N-best list of single or multiple word reference patterns and associated parameter values may be generated and further evaluated.

In one example, the speech recognition decoder 214 processes the feature vectors using the appropriate acoustic models, grammars, and algorithms to generate an N-best list of reference patterns. As used herein, the term reference patterns is interchangeable with models, waveforms, templates, rich signal models, exemplars, hypotheses, or other types of references. A reference pattern can include a series of feature vectors representative of one or more words or subwords and can be based on particular speakers, speaking styles, and audible environmental conditions. Those skilled in the art will recognize that reference patterns can be generated by suitable reference pattern training of the ASR system and stored in memory. Those skilled in the art will also recognize that stored reference patterns can be manipulated, wherein parameter values of the reference patterns are adapted based on differences in speech input signals between reference pattern training and actual use of the ASR system. For example, a set of reference patterns trained for one user or certain acoustic conditions can be adapted and saved as another set of reference patterns for a different user or different acoustic conditions, based on a limited amount of training data from the different user or the different acoustic conditions. In other words, the reference patterns are not necessarily fixed and can be adjusted during speech recognition.

The speech recognition decoder 214 may also incorporate one or more conversational context-specific language models to identify a conversational context corresponding to the feature vectors. Also, the conversational context can include “humor” for a humorous conversation, or “dinner” for a conversation about dinner plans, or “romantic” for an amorous conversation, or “gossip” for gossipy chat, or “invitation” for invitations and related responses, or “greetings” for introductory types of conversations. The conversational context can include one or more of any of the aforementioned examples, and/or any other suitable types of conversational contexts. Each of the conversational context-specific language models may also correspond to one conversational context, and can be developed and trained in any suitable manner by a plurality of speakers before speech recognition runtime.

The speech recognition decoder 214 may further incorporate one or more emotional context-specific language models to identify an emotional context corresponding to the feature vectors. Also, the emotional context can include “anger” for hostile conversation, or “happy” for upbeat conversation, or “sad” for unhappy conversations, or “confused” or the like. The emotional context can include one or more of any of the aforementioned examples, and/or any other suitable types of emotional contexts. In one embodiment, each of the emotional context-specific language models corresponds to one emotional context, and can be developed and trained in any suitable manner by a plurality of speakers before speech recognition runtime. It should be understood these language models can include a permutation matrix of conversational/emotional models. For instance, the models can include a “dinner”/“happy” model, a “dinner”/“angry” model, a “gossip”/“confused” model, and the like.

Using the in-vocabulary grammar and any suitable decoder algorithm(s) and acoustic model(s), the processor accesses from memory several reference patterns interpretive of the test pattern. For example, the processor can generate, and store to memory, a list of N-best vocabulary results or reference patterns, along with corresponding parameter values. Illustrative parameter values can include confidence scores of each reference pattern in the N-best list of vocabulary and associated segment durations, likelihood scores, signal-to-noise ratio (SNR) values, and/or the like. The N-best list of vocabulary can be ordered by descending magnitude of the parameter value(s). For example, the vocabulary reference pattern with the highest confidence score is the first best reference pattern, and so on. Once a string of recognized subwords are established, they can be used to construct words with input from the word models 222 and to construct sentences with the input from the language models 224.

Finally, the post-processor software module(s) 216 receives the output data from the decoder module(s) 214 for any suitable purpose. In one example, the post-processor software module(s) 216 can identify or select one of the reference patterns from the N-best list of single or multiple word reference patterns as recognized speech. In another example, the post-processor module(s) 216 can be used to convert acoustic data into text or digits for use with other aspects of the ASR system or other vehicle systems. In a further example, the post-processor module(s) 216 can be used to provide training feedback to the decoder 214 or pre-processor 212. More specifically, the post-processor 216 can be used to train acoustic models for the decoder module(s) 214, or to train adaptation parameters for the pre-processor module(s) 212.

### Method

The method or parts thereof can be implemented in a computer program product (e.g., a virtual assistant device 53, server 82, mobile computing device 57, telematics unit 30, etc.) embodied in a computer readable medium and including instructions usable by one or more processors of one or more computers of one or more systems to cause the system(s) to implement one or more of the method steps. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

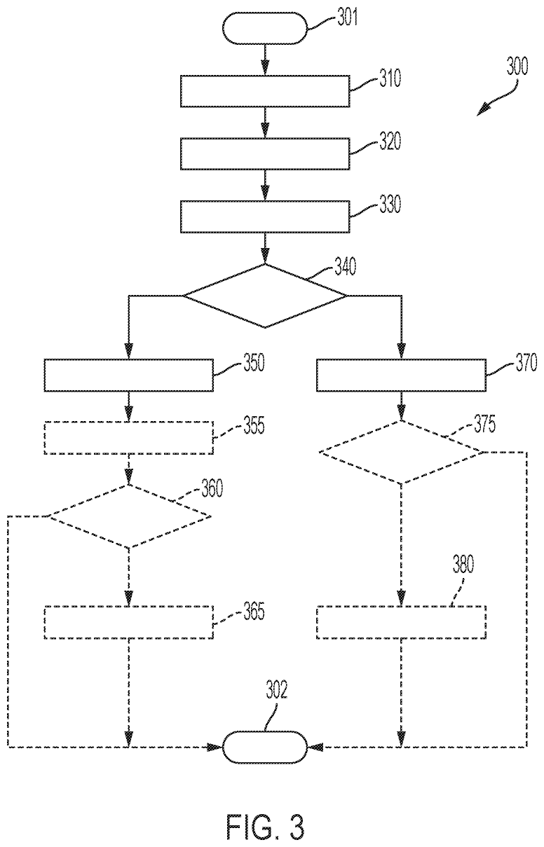

Turning now to FIG. 3, there is shown a method 300 that can be carried out using suitable programming of the automatic speech recognition system 210 of FIG. 2 using suitable hardware and programming as well as other suitable components shown in FIGS. 1 and 2. For example, speech recognition hardware, firmware, and software of ASR system 210 can resident in a virtual assistant device 53 (such as, for example, an Echo™ by Amazon™), on the computer 18, on one of the servers 82 in the data center 20, or on mobile computing device 57. Such programming and use of the hardware described above will be apparent to those skilled in the art based on the above system description and the discussion of the method described below in conjunction with the remaining figures. Those skilled in the art will also recognize that the methods can be carried out using other ASR systems 210 within other operating environments. The method steps may or may not be sequentially processed, and the invention(s) may encompass any sequencing, overlap, or parallel processing of such steps.

Method 300 begins with 301 in which microphone 32 is configured to listen for speech and is embedded into a virtual assistant device 53. In 301, moreover, the virtual assistant device 53 and telematics unit 30 is in constant communication with data center 20, for example, via wireless carrier system 14. Thus, any recognized speech input picked up by microphone 32 as acoustic data that will be relayed/transmitted to data center 20 over carrier system 14. For example, the data can be sent via packet data transmissions via data over voice protocol, and/or via any other suitable manner. It should be understood that microphone 32 may alternatively be installed onto mobile computing device 57 and can listen while this device is in range of the user. Thus, mobile computing device 57 may also be in constant communication with data center 20.

In step 310, user speech request inputs are recognized and obtained by microphone 32. The speech request may include a Wake-Up-Word directly or indirectly followed by a request for services. For example, a Wake-Up-Word is a speech command made by the user that allows the voice assistant to realize activation (i.e., to wake up the system while in a sleep mode). For example, in various embodiments, a Wake-Up-Word can be “HELLO SIRI/ALEXA/GOOGLE” or, more specifically, the word “HELLO” (i.e., when the Wake-Up-Word is in the English language). In addition, the request for services is a request to activate a home emergency sequence through vehicle 12. For example, in various embodiments, a request to activate a home emergency sequence can be “I HAVE AN EMERGENCY AT HOME” or, more specifically, the word “TELL CHEVROLET™ THAT I HAVE AN EMERGENCY AT HOME” (i.e., when a vehicle 12 or user account has been associated with the virtual assistant device 53). The home emergency sequence may be to, for example, activate the known horn system and head lamp lights of the vehicle 12 in a certain sequence (discussed below).

ASR system 210 then processes the speech data and recognize whether that the speech data contains a home emergency sequence request. For instance, ASR system 210 provides acoustic data that represents the voice tones, voice inflections, and speech patterns of the user. When such speech data shows it includes the home emergency sequence request, method will move to step 320 in an alternative embodiment, the microphone 32 listens to an instance of speech occurring in its vicinity and transmits it to the ASR system 210 installed onto mobile computing device 57 or computer 18.

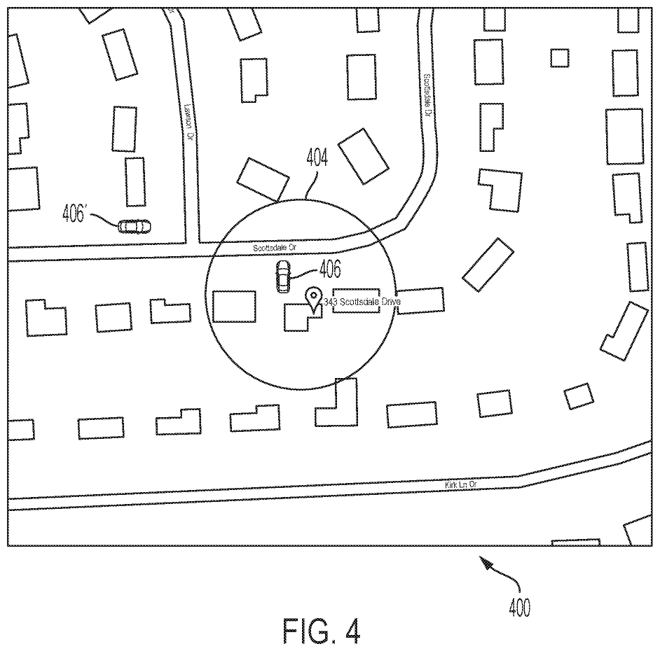

In step 320, the virtual assistant device will transmit the home emergency sequence request to server 82 via wireless carrier system 14. In step 330, as can be seen with additional reference to FIG. 4, after the request has been properly received by server 82, server 82 will retrieve a virtual map 400 from mapping application 61 (e.g., resident on computer 18). Server 82 will also retrieve the residence address of the system user from one or more lookup tables stored in database 84 and establish a residence location (represented as the dropped pin) on virtual map 400. This information may have been previously provided and incorporated into database 84 when the user set up a vehicle user account with data center 20 (and they may have also associated the identification number of the virtual assistant device 53 with this user account). Moreover, in this step, server 82 will establish a virtual geographic boundary 404 (e.g., geofence) around the residence established on the virtual map. The virtual geographic boundary 404 can represent, for example, a radius of 50 yards around the residence location. In another embodiment, the geographic boundary can represent the property line of the user's residence.

In step 330, server 82 will attain the GPS coordinates of vehicle 12 (vehicle location data) by communicating with telematics unit 30 and GPS module 40. In addition, server 82 will establish a virtual vehicle location 406 on virtual map 400. Skilled artists will see that establishing locations on virtual maps 400 has been well known in the art.

In step 340, server 82 will determine if the virtual vehicle location 406 falls within the virtual geographic boundary 404. When the virtual vehicle location 406 is considered to be located within the virtual geographic boundary 404 (i.e., the vehicle is located within proximity of the residence of the system user), method 300 will move to step 350. Otherwise, however, when the virtual vehicle location 406′ is considered to be located outside of the virtual geographic boundary 404 (i.e., the vehicle is located beyond the proximity of the user's residence), method 300 will move to step 370.

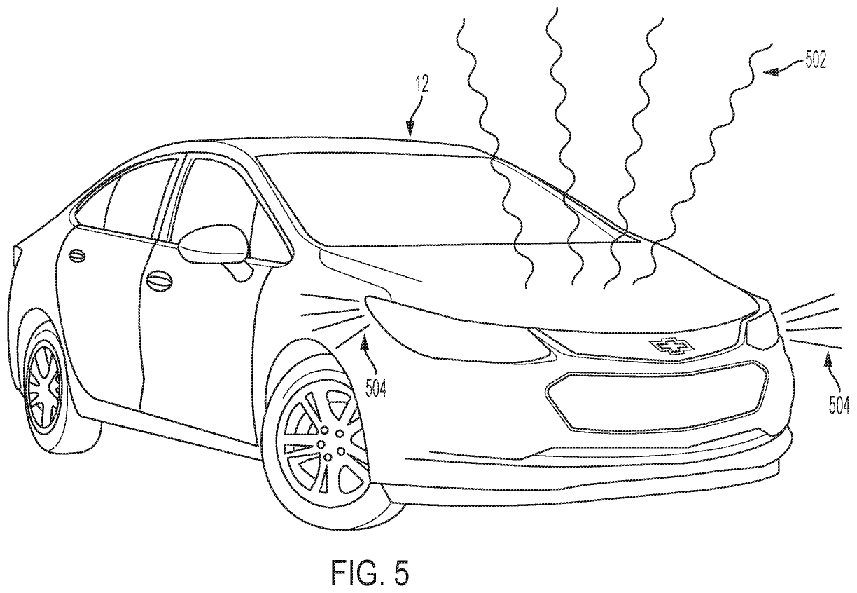

In step 350, server 82 will transmit a vehicle alarm notification to the vehicle 12. As can be understood with reference to FIG. 5, once received by vehicle 12, moreover, this alarm notification will cause telematics unit 30 (or any other vehicle computer system) to activate the vehicle's horn system 502 as well as light system 504 (i.e., the vehicle head and tail lamps) in an ordered sequence. As follows, this sequential activation of the vehicle horn and light systems can be similar to the activation of a known vehicle theft alarm system. For instance, the horn and light systems 502, 504 may be activated as if a near by vehicle operator pressed their remote panic button (i.e., to intermittently play the horn and intermittently illuminate the lights). Moreover, activating these systems 502, 504 in an ordered sequence may also get the attention of the nearby pedestrians and neighbors, so they can be alerted to an emergency occurring at the system user's residence (e.g., a burglary or home invasion situation). Skilled artists will see that the vehicle alarm notification can be sent to all vehicles associated with the user and/or residence address and which are found to be within the virtual geographic boundary 404.

In optional step 355, after the horn and light systems 502, 504 have been activated, vehicle 12 will transmit an activation indication back to server 82. In response to receiving this indication, server 82 will transmit an affirmation notification to be played at a speaker (not shown) of the virtual assistant device 53. This affirmation is designed to notify the user that the vehicle's horn and light systems have been activated. For example, in various embodiments, the affirmation can be “[USER NAME], YOUR VEHICLE(S) ALARM SYSTEMS HAVE BEEN ACTIVATED.”

In optional step 360, the affirmation notification also includes an inquiry as to whether the system user wishes to inform an emergency services provider 75 that an emergency is potentially occurring at their residential address. For example, in various embodiments, the inquiry can be “[USER NAME], WOULD YOU ALSO LIKE US TO NOTIFY THE POLICE?” If the system user responds to the inquiry in a positive manner (i.e., by saying “yes” or the like), then method 300 will move to optional step 375; otherwise, method 300 will move to completion 302. In optional step 365, server 82 will transmit an emergency services notification to the emergency services provider 75. For example, in various embodiments, the emergency services notification can state “THERE IS A POTENTIAL EMERGENCY SITUATION OCCURRING AT [343 SCOTTSDALE DRIVE].” This notification may also be a text message displayed on a computer screen of the dispatch operator within emergency services provider 75 or may be an automated call made to the dispatch operator at the emergency services provider 75. The emergency service providers can moreover use the received emergency services notification to motivate them to investigate the situation occurring at the service user's residence. After optional step 365, method 300 will move to completion 302.

In step 370, server 82 will transmit a rejection notification to be played at a speaker of the virtual assistant device 53 (not shown). This affirmation is designed to notify the user that vehicle 12 is located beyond the proximity of the user's residence. For example, in various embodiments, the affirmation can be “[USER NAME], NO VEHICLE(S) ARE PRESENT AT YOUR RESIDENCE.”

In optional step 375, the rejection notification also includes an inquiry as to whether the system user wishes to inform an emergency services provider 75 that an emergency is potentially occurring at their residential address. For example, in various embodiments, this inquiry can be “[USER NAME], DO YOU WANT TO NOTIFY THE POLICE INSTEAD?” If the system user responds to the inquiry in a positive manner (i.e., by saying “yes” or the like), then method 300 will move to optional step 380; otherwise, method 300 will move to completion 302. In optional step 380, server 82 will transmit an emergency services notification to the emergency services provider 75. As stated above, the emergency services notification can state “THERE IS A POTENTIAL EMERGENCY SITUATION OCCURRING AT [343 SCOTTSDALE DRIVE]” and can be a text message displayed on a computer at the emergency services provider 75 or it may be an automated call made to the emergency services provider 75. After optional step 380, method 300 will move to completion 302.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the system and/or method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

What is claimed is:

1. A method for remotely activating a vehicle alarm via a voice command, the method comprising:
receiving, via a processor, a voice command to activate a home emergency sequence from a system user;
based on the voice command, via the processor, determining if one or more vehicles are located in proximity to a residence of the system user; and
when the one or more vehicles are located in proximity to the residence, via the processor, transmitting a vehicle alarm notification to the one or more vehicles, wherein the vehicle alarm notification is configured to activate a horn system and a light system of the one or more vehicles in an ordered sequence.

2. The method of claim 1, further comprising:
receiving, via the processor, an indication that the horn and light systems of the one or more vehicles have been activated; and
in response to receiving the indication, via the processor, transmitting a first audible notification to the user, wherein the first audible notification is configured to notify the user that the horn and light systems of the one or more vehicles have been activated.

3. The method of claim 2, further comprising:
wherein the first audible notification is further configured to inquire whether the user wishes to inform an emergency services provider; and
when the user wishes to inform the emergency services provider, via the processor, transmitting an emergency services notification to the emergency services provider, wherein the emergency services notification is configured to inform the emergency services provider that an emergency event may be occurring at the residence of the user.

4. The method of claim 1, further comprising, when the one or more vehicles are located beyond the proximity of the residence, via the processor, transmitting a second audible notification to the user, wherein the second audible notification is configured to notify the user that the one or more vehicles are beyond the proximity of the residence.

5. The method of claim 1, further comprising:
receiving, via the processor, vehicle location data from the one or more vehicles; and
wherein the determination of whether the one or more vehicles are located in proximity to the residence of the system user is based on the vehicle location data.

6. The method of claim 1, further comprising:
receiving, via the processor, a virtual map from a remote entity;
establishing, via the processor, the residence of the system user within the virtual map; and
wherein the determination of whether the one or more vehicles are located in proximity to the residence of the system user is based on the residence of the system user within the virtual map.

7. The method of claim 1, further comprising:
receiving, via the processor, a virtual map from a remote entity;
establishing, via the processor, the residence of the system user within the virtual map;
receiving, via the processor, vehicle location data from the one or more vehicles;
establishing, via the processor, a virtual geographic boundary around the residence of the system user within the virtual map; and
wherein a vehicle of the one or more vehicles is considered to be located in proximity to the residence of the system user when the vehicle location data shows the vehicle is within the established virtual geographic boundary.

8. A system for remotely activating a vehicle alarm via a voice command, the system comprising:
a memory configured to comprise one or more executable instructions and a processor configured to execute the executable instructions, wherein the executable instructions enable the processor to:
receive a voice command to activate a home emergency sequence from a system user;
based on the voice command, determine if one or more vehicles are located in proximity to a residence of the system user; and
when the one or more vehicles are located in proximity to the residence, transmit a vehicle alarm notification to the one or more vehicles, wherein the vehicle alarm notification is configured to activate a horn system and a light system of the one or more vehicles in an ordered sequence.

9. The system of claim 8, wherein the executable instructions further enable the processor to:
receive an indication that the horn and light systems of the one or more vehicles have been activated; and
in response to receiving the indication, transmit a first audible notification to the user, wherein the first audible notification is configured to notify the user that the horn and light systems of the one or more vehicles have been activated.

10. The system of claim 9, wherein the executable instructions further enable the processor to:
wherein the first audible notification is further configured to inquire whether the user wishes to inform an emergency services provider; and
when the user wishes to inform the emergency services provider, transmit an emergency services notification to the emergency services provider, wherein the emergency services notification is configured to inform the emergency services provider that an emergency event may be occurring at the residence of the user.

11. The system of claim 8, wherein the executable instructions further enable the processor to, when the one or more vehicles are located beyond the proximity of the residence, transmit a second audible notification to the user, wherein the second audible notification is configured to notify the user that the one or more vehicles are beyond the proximity of the residence.

12. The system of claim 8, wherein the executable instructions further enable the processor to:
receive vehicle location data from the one or more vehicles; and
wherein the determination of whether the one or more vehicles are located in proximity to the residence of the system user is based on the vehicle location data.

13. The system of claim 8, wherein the executable instructions further enable the processor to:
receive a virtual map from a remote entity;
establish the residence of the system user within the virtual map; and
wherein the determination of whether the one or more vehicles are located in proximity to the residence of the system user is based on the residence of the system user within the virtual map.

14. The system of claim 8, wherein the executable instructions further enable the processor to:
receive a virtual map from a remote entity;
establish the residence of the system user within the virtual map;
receive vehicle location data from the one or more vehicles;
establish a virtual geographic boundary around the residence of the system user within the virtual map; and
wherein a vehicle of the one or more vehicles is considered to be located in proximity to the residence of the system user when the vehicle location data shows the vehicle is within the established virtual geographic boundary.

15. A non-transitory and machine-readable medium having stored thereon executable instructions adapted to remotely activate a vehicle alarm via a voice command, which when provided to a processor and executed thereby, causes the processor to:
receive a voice command to activate a home emergency sequence from a system user;
based on the voice command, determine if one or more vehicles are located in proximity to a residence of the system user; and
when the one or more vehicles are located in proximity to the residence, transmit a vehicle alarm notification to the one or more vehicles, wherein the vehicle alarm notification is configured to activate a horn system and a light system of the one or more vehicles in an ordered sequence.

16. The non-transitory and machine-readable memory of claim 15, which further causes the processor to:
receive an indication that the horn and light systems of the one or more vehicles have been activated; and
in response to receiving the indication, transmit a first audible notification to the user, wherein the first audible notification is configured to notify the user that the horn and light systems of the one or more vehicles have been activated.

17. The non-transitory and machine-readable memory of claim 16, which further causes the processor to:
wherein the first audible notification is further configured to inquire whether the user wishes to inform an emergency services provider; and
when the user wishes to inform the emergency services provider, transmit an emergency services notification to the emergency services provider, wherein the emergency services notification is configured to inform the emergency services provider that an emergency event may be occurring at the residence of the user.

18. The non-transitory and machine-readable memory of claim 15, which further causes the processor to, when the one or more vehicles are located beyond the proximity of the residence, transmit a second audible notification to the user, wherein the second audible notification is configured to notify the user that the one or more vehicles are beyond the proximity of the residence.

19. The non-transitory and machine-readable memory of claim 15, which further causes the processor to:
receive vehicle location data from the one or more vehicles; and
wherein the determination of whether the one or more vehicles are located in proximity to the residence of the system user is based on the vehicle location data.

20. The non-transitory and machine-readable memory of claim 15, which further causes the processor to:
receive a virtual map from a remote entity;
establish the residence of the system user within the virtual map;
receive vehicle location data from the one or more vehicles;
establish a virtual geographic boundary around the residence of the system user within the virtual map; and
wherein a vehicle of the one or more vehicles is considered to be located in proximity to the residence of the system user when the vehicle location data shows the vehicle is within the established virtual geographic boundary.
